(19) United States
(12) Patent Application Publication
(10) Pub. No.: US 2005/0285880 A1
(43) Pub. Date: Dec. 29, 2005

(54) Method of magnifying a portion of display

(75) Inventors: Cheng-Shing Lai, Taipei Hsien (TW); Cong Wu, Nanking (CN)

Correspondence Address: BACON & THOMAS, PLLC, 625 SLATERS LANE, FOURTH FLOOR, ALEXANDRIA, VA, 22314, US

(73) Assignee: Inventec Appliances Corporation, Taipei Hsien (TW)

(21) Appl. No.: 10/873,187

(22) Filed: Jun. 23, 2004

(51) Int. Cl. G09G 5/00

(52) U.S. Cl. 345/660

(57) ABSTRACT

The present invention discloses a method of magnifying a portion of a display of a portable communication device, which is implemented in the portable communication device including a magnification software being executed to perform the steps of taking a selected location of the display of the portable communication device as a magnifying point; selecting the portion of the display based on the magnifying point and the magnifying area; and obtaining a magnified portion by multiplying the selected portion of the display by the magnification. By utilizing the present invention, letters and icon within the magnified portion will be larger than letters and icons in other portions of the display.

### FIELD OF THE INVENTION

The present invention relates to screen magnifying methods and more particularly to a method of magnifying an interesting portion of display of a portable electronic device such as cellular phone or PDA (Personal Digital Assistant).

### BACKGROUND OF THE INVENTION

Over the past several decades there has been a simultaneous growth in information technology and electronics, bringing a great convenience to human being. Also, they are closely related to our daily life and work. In addition, people have an increasing demand to the quality of the information products as they are available in an even faster pace. For keeping up with the trend, manufacturers constantly develop new information products with additional and/or enhanced features. This is particularly true for the portable communication products (e.g., cellular phones, PDAs, etc.) in information products since portable communication products have become indispensable communication tools for most people in their daily life. The portable communication products have features of short messages sending in addition to its default communication capability. Further, the portable communication products are advantageous for being compact and easily carried by the hand. As such, the portable communication products have become a very important, general personal communication tool.

It is understood that the information product market is very competitive due to the wide popularity of the portable communication products. In view of many different types of cellular phone and PDA being commercially available, it is highly possible that a portable communication product not meeting the quality demand of consumer will be eliminated from the market. Thus, an indicator about whether technology owned by a portable communication product manufacturer is more advanced than that of other competitive ones can be decided based on whether portable communication products produced by that manufacturer can provide a more convenient service and a more effective operation.

The trend of developing portable communication products is slimness, compactness, and multifunction. As such, internal space of the portable communication product is reduced significantly. Further, mechanisms of the portable communication product are more difficult to design due to the addition of many advanced features. The display of the portable communication product is reduced accordingly. For showing a fine and pleasing picture on the small screen of the display, the display is typically set at a high resolution mode. This in turn further decreases the sizes of icons, numbers, and letters shown on display. Hence, a myopic or presbyopic user may not clearly see or even cannot see the content shown on the display.

A user may set the display at a low resolution mode for the purpose of clearly seeing pictures shown on the display. However, it not only contradicts the spirits of providing a high resolution mode on the display but also causes the display to show a smaller picture. Thus, a user has to repeatedly use horizontal and vertical scrolls to adjust the screen to an optimum position for operation. This can bring a lot of trouble and inconvenience in use. A user may use one hand to hold a magnifying lens to view the display and the other hand to hold the portable communication product if the user does not want to set the display at a low resolution mode. However, the user cannot use a pen to click an icon on the display or press a key on the portable communication product in such case. This in turn is inconvenient. Thus, it is desirable to provide a method of enabling a user to see a magnified icon or letter(s) on the display set at a high resolution mode without modifying the existing configuration.

### SUMMARY OF THE INVENTION

A primary object of the present invention is to provide a method of magnifying a portion of a display of a portable communication device. The method is implemented in the portable communication device including a magnification software. When the portable communication device runs the magnification software the magnification software performs the steps of taking a selected location of the display of the portable communication device as a magnifying point; selecting the portion of the display based on the magnifying point and the magnifying area; and obtaining a magnified portion by multiplying the selected portion of the display by the magnification. By utilizing the present invention, letters and icon within the magnified portion will be larger than letters and icons in other portions of the display.

The above and other objects, features and advantages of the present invention will become apparent from the following detailed description taken with the accompanying drawings.

### BRIEF DESCRIPTION OF THE DRAWINGS

FIG. 1 shows a screen full of icons and associated descriptive words on a conventional display;

FIG. 2 shows the screen with one icon and its descriptive word being magnified by the method of the invention;

FIG. 3 is a flow chart illustrating a process of running an object magnification software according to the invention;

FIG. 4 is a flow chart illustrating a process of magnifying an object in a magnifying shape mode according to the invention;

FIG. 5 shows a screen of setting parameters according to the invention;

FIG. 6 shows pixels before and after magnification respectively; and

FIG. 7 schematically depicts a predetermined portion on the screen according to the invention.

### DETAILED DESCRIPTION OF THE PREFERRED EMBODIMENTS

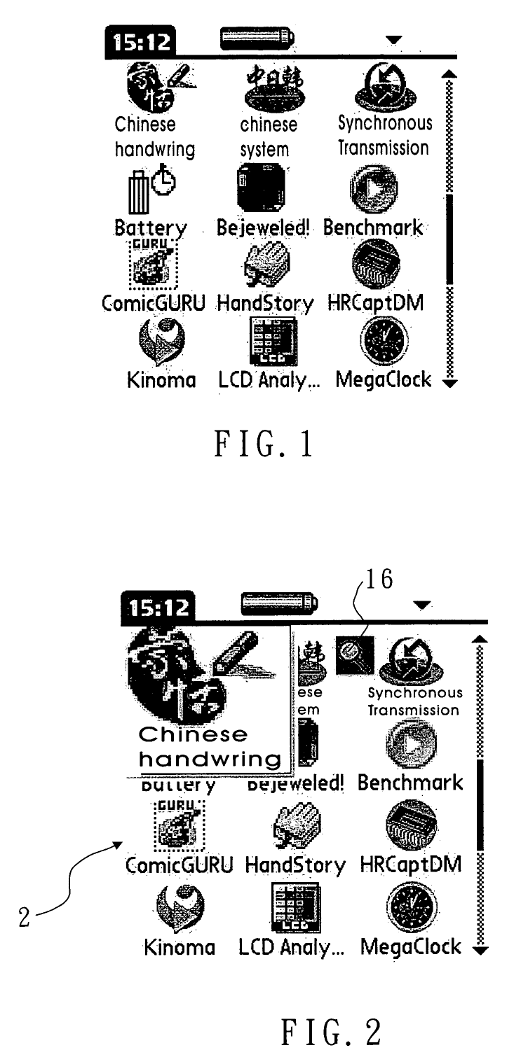

Referring to FIGS. 1, 2, and 5, there is shown a method of magnifying a portion of display in accordance with the invention. The method is implemented in a portable communication device including a magnification software 1 having at least one magnifying shape mode 10 each having a magnifying area 12 and a magnification 14. In a case of the portable communication device runs the magnification software 1, a selected location of the display of the portable communication device is taken as a magnifying point. A portion of the display is then selected based on the magnifying point and the magnifying area 12. Also, a magnified portion is obtained by multiplying the selected portion of the display by the magnification 14. Letters and icon within the magnified portion will be larger than letters and icons in other portions of the display. As an end, the problem of experiencing a blurry outline of letters or icon on a high resolution display in the prior art can be solved.

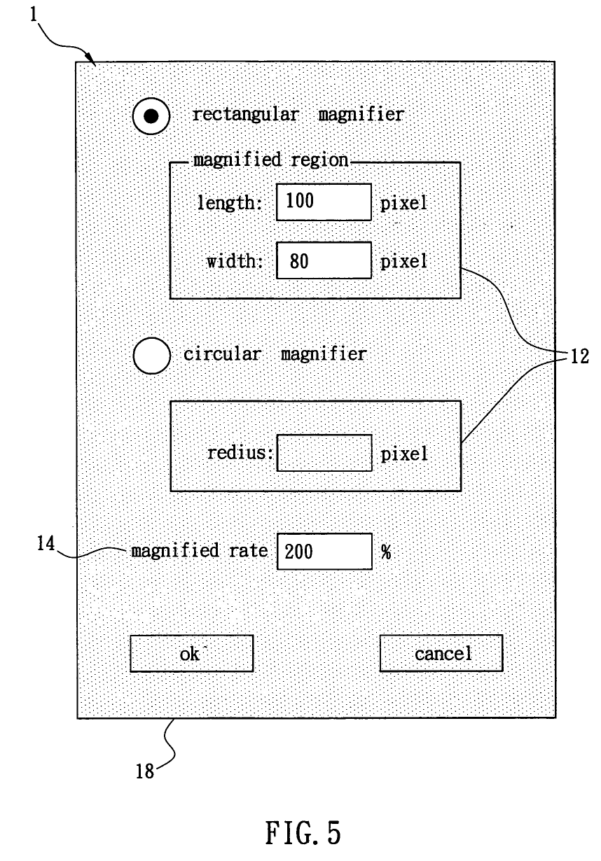

Referring to FIGS. 2 and 5 again, in a preferred embodiment of the invention the magnification software 1 further comprises a magnifying icon 16. In a case of the portable communication device runs the magnification software 1, a magnifying icon 16 is shown on the display 2. Clicking the magnifying icon 16 will enable the portable communication device to perform a subsequent processing based on the magnifying shape mode 10. In a case of the magnifying shape mode 10 activated, the magnifying shape mode 10 continuously selects the portion of the display by following the trace of the magnifying point. And the selected portion is magnified a specific magnification. The magnifying shape mode 10 will stop any subsequent actions if no magnifying point is read by the magnifying shape mode 10 in a predetermined period of time. The magnifying icon 16 is a moveable icon as any icons shown on a typical Window screen. A user can use an optical pen to press the magnifying icon 16 and drag the same to a desired place on the display. Preferably, the new location of the magnifying icon 16 does not cover any other icons or portions on the display to be operated.

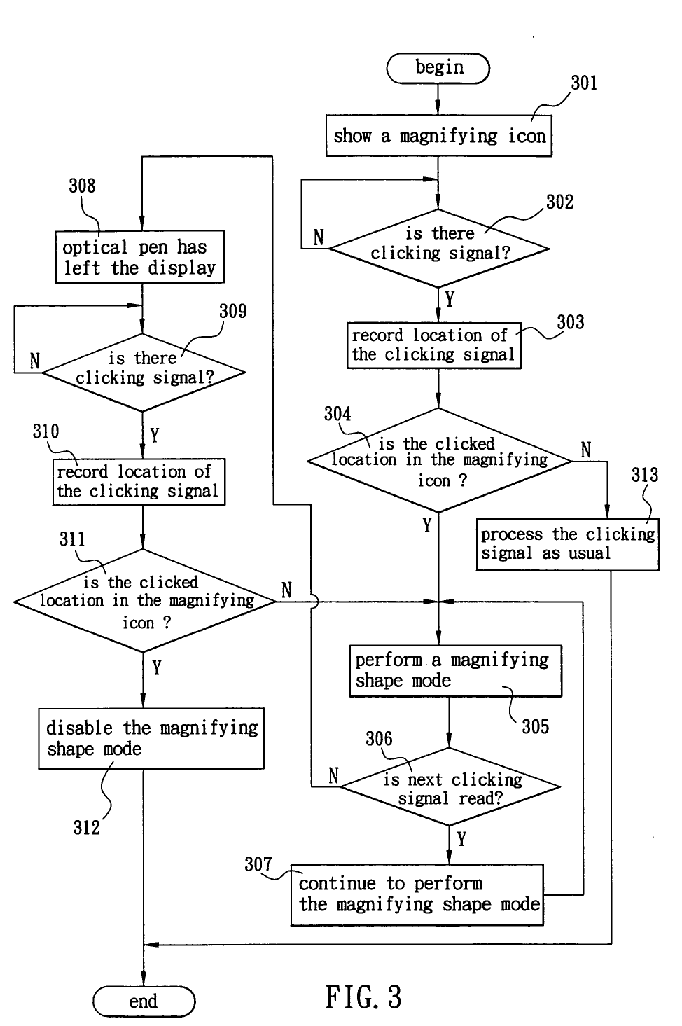

For further understanding the invention, a PDA having a touch screen is taken as an exemplary example. Referring to FIG. 3 in conjunction with FIG. 2, in a case of the magnification software 1 is run by an optical pen on the touch screen based display, the PDA performs the following steps to activate the magnifying shape mode 10.

In step 301, a magnifying icon 16 is shown on the display 2.

In step 302, it is determined whether a clicking signal is generated on the display 2. If yes, the process goes to step 303. Otherwise, the process loops back to itself.

In step 303, record the location of the clicking signal.

In step 304, it is determined whether the clicked location is within the range of the magnifying icon 16. If yes, the process goes to step 305. Otherwise, the process jumps to step 313.

In step 305, perform the selected magnifying shape mode 10.

In step 306, it is determined whether a next clicking signal is read. If yes, the process goes to step 307. Otherwise, the process jumps to step 308.

In step 307, continue to perform the selected magnifying shape mode 10.

In step 308, the optical pen is determined to have left the screen of the display 2 (i.e., no more new magnifying point being generated).

In step 309, it is determined whether a clicking signal is generated o the display 2. If yes, the process goes to step 310. Otherwise, the process loops back to itself.

In step 310, record the location of the clicking signal.

In step 311, it is determined whether the clicked location is within the range of the magnifying icon 16. If yes, the process goes to step 312. Otherwise, the process loops back to step 305.

In step 312, disable the selected magnifying shape mode 10.

In step 313, process the clicking signal as usual.

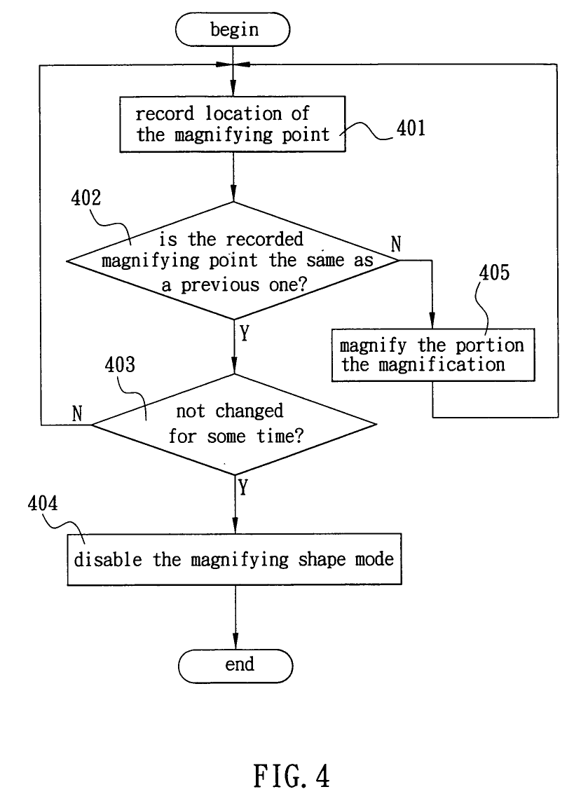

Referring to FIG. 4, in a case of the selected magnifying shape mode 10 activated to perform magnification, the PDA performs the following steps.

In step 401, record the location of the read magnifying point.

In step 402, it is determined whether the recorded magnifying point is the same as a previously recorded magnifying point. If yes, the process goes to step 403. Otherwise, the process jumps to step 405.

In step 403, it is determined whether the recorded magnifying point has not changed for a predetermined period of time. If yes, the process goes to step 404. Otherwise, the process loops back to step 401.

In step 404, the optical pen is determined to have left the screen of the display 2 (i.e., no more new magnifying point being generated). The magnifying shape mode is disabled immediately (i.e., the process ends).

In step 405, a portion of the display 2 is selected based on the magnifying point and the magnifying area 12. Also, a magnified portion is obtained by multiplying the selected portion of the display by the magnification 14. The process ends.

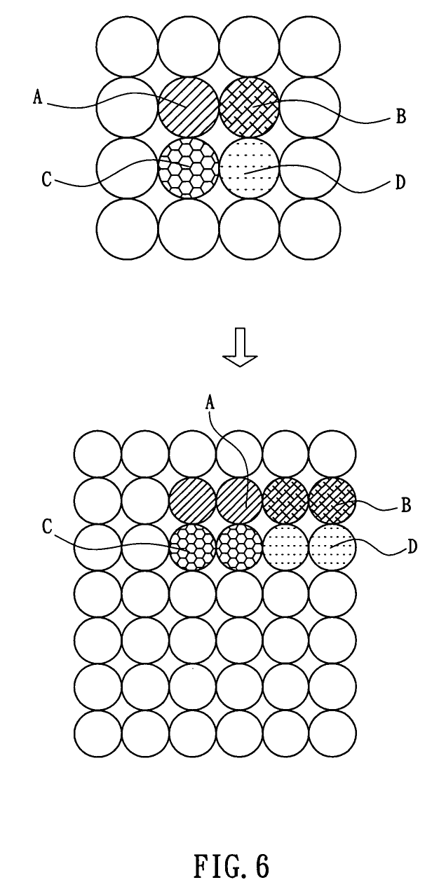

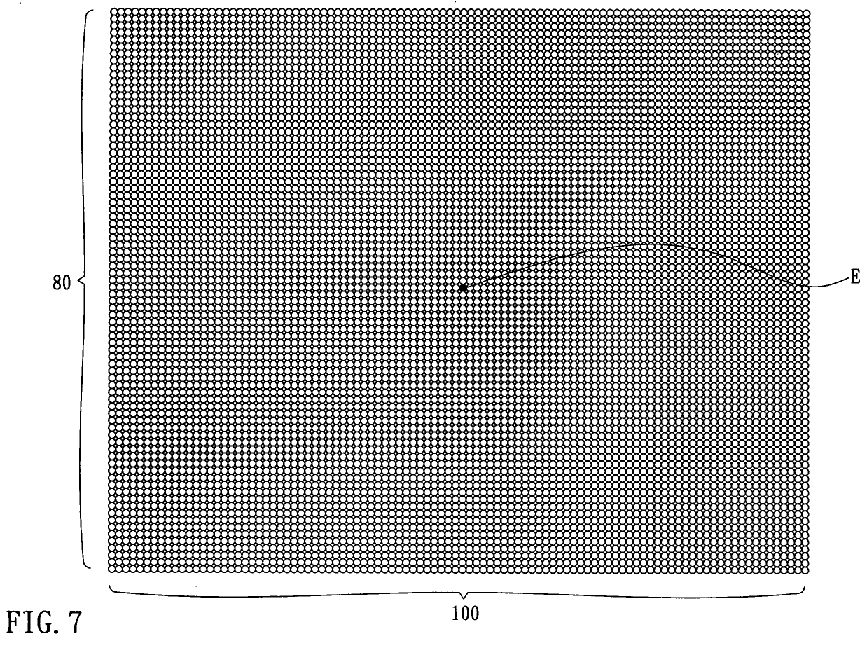

Referring to FIG. 5, in the invention the magnification software 1 comprises a parameter set table 18 for specifying the magnifying shape mode 10. The magnifying shape mode 10 comprises a magnifying area 12 and a magnification 14. In a case of the selected portion of the display 2 magnified by running the magnification software 1, pixels in the portion are magnified the magnification 14. Referring to FIG. 6, four adjacent pixels A, B, C, and D in the portion are shown. In the upper part of the figure, the pixels A, B, C, and D are shown in their apparent sizes. In the lower part of the figure, the pixels A, B, C, and D are magnified two times in which the magnified pixel A, B, C, or D is represented by two original pixels disposed laterally. Referring to FIG. 7 in conjunction with FIG. 5, the magnifying area 12 is the center of the selected place. Next, it is shown by pixels set in the magnifying area 12. For example, if the magnifying shape mode 10 is a rectangle and if the magnifying point is pixel E with the magnifying area 12 having a length of 100 pixels and a width of 80 pixels, then there are 100 pixels at either end of the pixel E and 80 pixels at either side thereof respectively. Such rectangular area is set as the magnifying area 12. Thus, a user may, as desired, set the magnifying area 12 and the magnification 14 for optimally increasing the apparent size of the icon and/or associated letters in the magnifying point 10.

While the invention has been described by means of specific embodiments, numerous modifications and variations could be made thereto by those skilled in the art without departing from the scope and spirit of the invention set forth in the claims.

1. A method of magnifying a portion of a display of a portable communication device, the method being implemented in the portable communication device including a magnification software having at least one magnifying shape mode each having a magnifying area and a magnification so that when the portable communication device runs the magnification software, the magnification software performs the steps of:
taking a selected location of the display of the portable communication device as a magnifying point;
selecting the portion of the display based on the magnifying point and the magnifying area; and
obtaining a magnified portion by multiplying the selected portion of the display by the magnification.

2. The method of claim 1, wherein the magnification software further comprises a magnifying icon which, when the portable communication device runs the magnification software, the magnifying icon is shown on the display so that clicking the magnifying icon will enable the portable communication device to perform a subsequent processing based on the magnifying shape mode.

3. The method of claim 2, wherein in response to activating the magnifying shape mode, the magnifying shape mode continuously selects the portion of the display by following a trace of the magnifying point and magnifying the selected portion of the display the magnification.

4. The method of claim 3, wherein the magnifying shape mode will stop any subsequent actions if no magnifying point is read by the magnifying shape mode in a predetermined period of time.

5. The method of claim 4, wherein responsive to running the magnification software, the portable communication device performs the steps of:
showing the magnifying icon on the display;
firstly determining whether a clicking signal is generated on the display;
if the first determination is positive recording a location of the clicking signal;
secondly determined whether the clicked location is within a range of the magnifying icon;
if the second determination is positive performing the selected magnifying shape mode;
thirdly determined whether a next clicking signal is read; and
if the third determination is positive continuously performing the selected magnifying shape mode.

6. The method of claim 5, wherein responsive to reading a next clicking signal no more, the optical pen is determined to have left the display with no more new magnifying point being generated and the selected magnifying shape mode being disabled.

7. The method of claim 5, wherein responsive to activating the selected magnifying shape mode to perform magnification, the PDA performs the steps of:
recording a location of the read magnifying point;
firstly determining whether the recorded magnifying point is the same as a previously recorded magnifying point;
if the first determination is positive secondly determining whether the recorded magnifying point has not changed for a predetermined period of time; and
if the second determination is positive determining that the optical pen has left the display with no more new magnifying point being generated and the selected magnifying shape mode being disabled.

8. The method of claim 7, wherein responsive to determining that the recorded magnifying point is different from the previously recorded magnifying point, further comprises the steps of:
selecting the portion of the display based on the magnifying point and the magnifying area; and
obtaining a magnified portion by multiplying the selected portion of the display by the magnification.

9. The method of claim 1, wherein the magnification software further comprises a parameter set table for specifying a magnifying shape mode including a magnifying area and a magnification.
